(19) United States
(12) Patent Application Publication
(10) Pub. No.: US 2026/0004798 A1
(43) Pub. Date: Jan. 1, 2026

(54) ADJUSTING SPEECH RATE FOR AN AUDIO INPUT

(71) Applicant: INTERNATIONAL BUSINESS MACHINES CORPORATION, Armonk, NY (US)

(72) Inventor: Mikael Hillborg, Umeå (SE)

(21) Appl. No.: 18/792,750

(22) Filed: Aug. 2, 2024

(30) Foreign Application Priority Data
Jul. 1, 2024 (GB) 2409467.4

(51) Int. Cl. G10L 21/043; G10L 15/02

(52) U.S. Cl. CPC G10L 21/043; G10L 15/02; G10L 2015/027

(57) ABSTRACT

According to one embodiment, a method, computer system, and computer program product for adjusting speech rate for an audio input is provided. The present invention may include applying syllable onset analysis to speech input in a buffer period; determining an average inter-syllable time for the buffer period; determining a rate adjustment required for the average inter-syllable time of the buffer period to conform to a target speech rate; applying a smoothing filter to smooth the rate adjustments across multiple sequential buffer periods; and adjusting the buffer period based on the smoothed rate adjustment.

### BACKGROUND

The present invention relates, generally, to the field of audio processing, and more particularly to adjusting a speech rate for an audio input.

Many individuals listen to spoken audio on its own or as part of a video; such individuals may have particular needs and preferences with respect to the speed at which the individual listens to spoken audio. For example, listeners may need to adjust an audio delivery rate due to hearing disorders, neurological disorders, or other reasons. Playback speed adjustment may be used to speed up audio playback to save time or to slow down audio playback to provide more time to process the audio.

There is a problem if multiple people are speaking because they have different speech rates and if an audio playback was increased when the audio started, this may need to be slowed down when another person starts speaking because it becomes difficult to hear what they are saying. In addition, the same presenter might make long pauses during certain passages and speak fast in other passages which creates the same problem.

The playback speech rate that a listener prefers is highly personal. Some people might prefer that a presenter speaks slowly or a bit faster. Depending on different presentations, the listener may require different settings.

Accessibility is a recognized requirement, and listeners may need to adjust an audio delivery rate due to hearing disorders, neurological disorders, or other reasons.

### SUMMARY

According to embodiments of the present invention, a method, computer system, and computer program product for adjusting speech rate for an audio input is provided. The present invention may include applying syllable onset analysis to speech input in a buffer period; determining an average inter-syllable time for the buffer period; determining a rate adjustment required for the average inter-syllable time of the buffer period to conform to a target speech rate; applying a smoothing filter to smooth the rate adjustments across multiple sequential buffer periods; and adjusting the buffer period based on the smoothed rate adjustment.

According to embodiments, a method, computer system, and computer program product for adjusting speech rate for an audio input is provided. The present invention may include applying syllable onset analysis to speech input in a buffer period; determining an average inter-syllable time for the buffer period; determining a rate adjustment required for the average inter-syllable time of the buffer period to conform to a target speech rate; adjusting the buffer period based on the rate adjustment; and overlapping consecutive buffer periods in the audio input and modifying an output signal in the overlapping portion for a smooth transition between adjacent buffer periods.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is an operational flowchart illustrating a speech rate adjusting process in accordance with embodiments of the present invention;

FIG. 2 is an operational flowchart illustrating a speech rate adjusting process in accordance with embodiments of the present invention;

FIG. 3A is a schematic diagram of an example embodiment illustrating an aspect of the method of syllable onset analysis;

FIG. 3B is a schematic diagram of an example embodiment illustrating an aspect of the method of smoothing a rate adjustment;

FIG. 3C is a schematic diagram of an example embodiment of an aspect of the method of overlapping buffers;

FIG. 4 is a block diagram of an example embodiment of a system in accordance with embodiments of the present invention; and

FIG. 5 is a block diagram of an example embodiment of a computing environment for the execution of at least some of the computer code involved in performing the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of a method, system, and computer program product are provided for adjusting speech rate of an audio input in order to provide a constant speech rate for the audio input. The described method and system relate to audio speech delivery in a speech input such as an audio file or part of a video file. The speech delivery may, for example, be a human voice or an artificially generated voice. The speech delivery may be a speech input received in real-time or in playback. For real-time speech input, the invention system may introduce latency that is the size of a buffer period as explained below.

The current disclosure provides a mechanism that enforces a constant speech rate in an audio input. This may accommodate a single speaker who may vary their rate of delivery or multiple speakers who speak at different rates. The constant speech rate may be selected by a user to suit their listening requirements.

In embodiments of the invention, the system may determine a speech rate of a speech input by taking an average of inter-syllable times in a buffer period and adjusting the rate of the speech (e.g., 5% up) in each buffer period to aim for a constant speech rate. The rate adjustment in each buffer period may be smoothed using a trajectory. Overlapping buffer periods may be used to provide smooth transitions. In some embodiments, only one of the trajectory smoothing or the overlapping buffer periods may be used. In embodiments, the system employs both trajectory smoothing and overlapping buffer periods. The speech rate adjustment results in a more constant speech rate that matches the user's preference without introducing any artifacts such as clicks or pops. The output audio is of high quality due to trajectory smoothing, the rate adjustment across buffer periods, and/or overlapping buffer periods which serve to smooth the transition between buffer periods.

Embodiments of the invention enable a user to select a target syllable rate and then applies the selected rate to the output buffer length to keep the speech delivery as close as possible to the selected rate. The system analyzes the speech rate of speech in a media file to identify how the rate of speech changes, and adjusts the rate of speech continuously to correct for any identified changes and match the selected target syllable rate.

Continuous adjustment of the audio input using the rate of the syllables which are continuously identified using onsets makes it possible to continuously perform selective adjustment locked to a personal preferred syllable rate. By using syllable onsets, the system distinguishes between a long stationary part and multiple consonants or vowels that cover the same amount of time.

As described herein, embodiments of the present invention provide improvements in the technical field of audio processing generally and more particularly in the technical field of audio processing including speech rate adjustment for playback.

According to an aspect of the present invention there is provided a computer-implemented method for adjusting speech rate for an audio input, the method comprising: applying syllable onset analysis to speech input in a buffer period; determining an average inter-syllable time for the buffer period; determining a rate adjustment required for the average inter-syllable time of the buffer period to conform to a target speech rate; applying a smoothing filter to smooth the rate adjustments across multiple sequential buffer periods; and adjusting the buffer period based on the smoothed rate adjustment.

In embodiments, the method provides the advantage of a constant rate audio output with a smoothed adjustment between buffer periods.

In embodiments, the method may include overlapping buffer periods and modifying a signal in the overlapping portion for a smooth transition between the smoothed rate adjustments of adjacent buffer periods. This has the advantage of preventing any artifacts in the audio output caused by the buffer transition.

In embodiments, adjusting the buffer period stretches the buffer period by a determined positive or negative ratio based on the smoothed rate adjustment.

In embodiments, the method may be carried out for a real-time audio input with a latency equal to the buffer period. The buffer period may be, as an example, a time period of between 2 and 5 seconds. Other lengths of buffer period may suit different situations.

In embodiments, the method may be carried out for an offline audio input and may include adjusting the length of the buffer period based on the speech input to avoid a buffer cut off mid-utterance; this has the advantage in an offline situation of adapting the buffer length to the speech delivery in the audio input to prevent buffer edges being mid syllable or word.

In embodiments, the method may use a temporary buffer of a same length as buffer period for syllable onset analysis, and the method may apply a bandpass filter to the temporary buffer based on a selected voice range; this may allow clearer syllable onset analysis.

In embodiments, determining an average inter-syllable time for the buffer period may comprise determining a median inter-syllable time to remove sensitivity to outliers.

In embodiments, applying a smoothing filter to smooth the rate adjustments across multiple sequential buffer periods may apply a smoothing filter that requires multiple consecutive rate adjustment values changing in a same direction before changing direction of a rate adjustment. Applying a smoothing filter to smooth the rate adjustments across multiple sequential buffer periods may apply a smoothing filter in a moving average window.

In embodiments, the method may include receiving a target speech rate for a user for the audio input. This allows the user to adjust the speech delivery rate to their listening requirements.

According to at least one aspect of the claimed invention there is provided a system comprising: a processor, a memory device coupled to the processor, and a computer readable storage device coupled to the processor, wherein the storage device contains program code executable by the processor via the memory device to implement a method for adjusting speech rate for an audio input, the method comprising: applying syllable onset analysis to speech input in a buffer period; determining an average inter-syllable time for the buffer period; determining a rate adjustment required for the average inter-syllable time of the buffer period to conform to a target speech rate; applying a smoothing filter to smooth the rate adjustments across multiple sequential buffer periods; and adjusting the buffer period based on the smoothed rate adjustment.

According to at least one aspect of the claimed invention there is provided a computer program product for adjusting speech rate for an audio input, the computer program product comprising a computer readable storage medium having program instructions embodied therewith, the program instructions executable by a processor to cause the processor to: apply syllable onset analysis to speech input in a buffer period; determine an average inter-syllable time for the buffer period; determine a rate adjustment required for the average inter-syllable time of the buffer period to conform to a target speech rate; apply a smoothing filter to smooth the rate adjustments across multiple sequential buffer periods; and adjust the buffer period based on the smoothed rate adjustment.

According to at least one aspect of the claimed invention there is provided a computer-implemented method for adjusting speech rate for an audio input, the method comprising: applying syllable onset analysis to speech input in a buffer period; determining an average inter-syllable time for the buffer period; determining a rate adjustment required for the average inter-syllable time of the buffer period to conform to a target speech rate; adjusting the buffer period based on the rate adjustment; and overlapping consecutive buffer periods in the audio input and modifying an output signal in the overlapping portion for a smooth transition between adjacent buffer periods.

This method has the advantage of preventing any artifacts in the audio output caused by the buffer transition whilst providing a constant output speech rate.

In embodiments, the method may include applying a smoothing filter to smooth the rate adjustments across multiple sequential buffer periods.

In embodiments, adjusting the buffer period may stretch the buffer period by an amount based on the rate adjustment.

According to at least one aspect of the present invention there is provided a system comprising: a processor, a memory device coupled to the processor, and a computer readable storage device coupled to the processor, wherein the storage device contains program code executable by the processor via the memory device to implement a method for adjusting speech rate for an audio input, the method comprising: applying syllable onset analysis to speech input in a buffer period; determining an average inter-syllable time for the buffer period; determining a rate adjustment required for the average inter-syllable time of the buffer period to conform to a target speech rate; adjusting the buffer period based on the rate adjustment; and overlapping consecutive buffer periods in the audio input and modifying an output signal in the overlapping portion for a smooth transition between adjacent buffer periods.

According to at least one aspect of the claimed invention there is provided a computer program product for adjusting speech rate for an audio input, the computer program product comprising a computer readable storage medium having program instructions embodied therewith, the program instructions executable by a processor to cause the processor to: apply syllable onset analysis to speech input in a buffer period; determine an average inter-syllable time for the buffer period; determine a rate adjustment required for the average inter-syllable time of the buffer period to conform to a target speech rate; adjust the buffer period based on the rate adjustment; and overlap consecutive buffer periods in the audio input and modifying an output signal in the overlapping portion for a smooth transition between adjacent buffer periods.

The computer readable storage medium may be a non-transitory computer readable storage medium, and the computer readable program code may be executable by a processing circuit.

The present invention seeks to provide one or more concepts for adjusting speech rate for an audio input. Such concepts may be computer-implemented. That is, such methods may be implemented in a computer infrastructure having computer executable code tangibly embodied on a computer readable storage medium having programming instructions configured to perform a proposed method. The present invention further seeks to provide a computer program product including computer program code for implementing the proposed concepts when executed on a processor. The present invention yet further seeks to provide a system for adjusting speech rate for an audio input.

References in the specification to “one embodiment,” “other embodiment,” “another embodiment,” “an embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to affect such feature, structure, or characteristic in connection with other embodiments whether or not explicitly described.

For purposes of the description hereinafter, the terms “upper”, “lower”, “right”, “left”, “vertical”, “horizontal”, “top”, “bottom”, and derivatives thereof shall relate to the disclosed structures and methods, as oriented in the drawing figures. The terms “overlying,” “atop,” “over,” “on,” “positioned on” or “positioned atop” mean that a first element is present on a second element wherein intervening elements, such as an interface structure, may be present between the first element and the second element. The term “direct contact” means that a first element and a second element are connected without any intermediary conducting, insulating, or semiconductor layers at the interface of the two elements.

In the interest of not obscuring the presentation of the embodiments of the present invention, in the following detailed description, some of the processing steps, materials, or operations that are known in the art may have been combined together for presentation and for illustration purposes and in some instances may not have been described in detail. Additionally, for brevity and maintaining a focus on distinctive features of elements of the present invention, description of previously discussed materials, processes, and structures may not be repeated with regard to subsequent Figures. In other instances, some processing steps or operations that are known may not be described. It should be understood that the following description is rather focused on the distinctive features or elements of the various embodiments of the present invention.

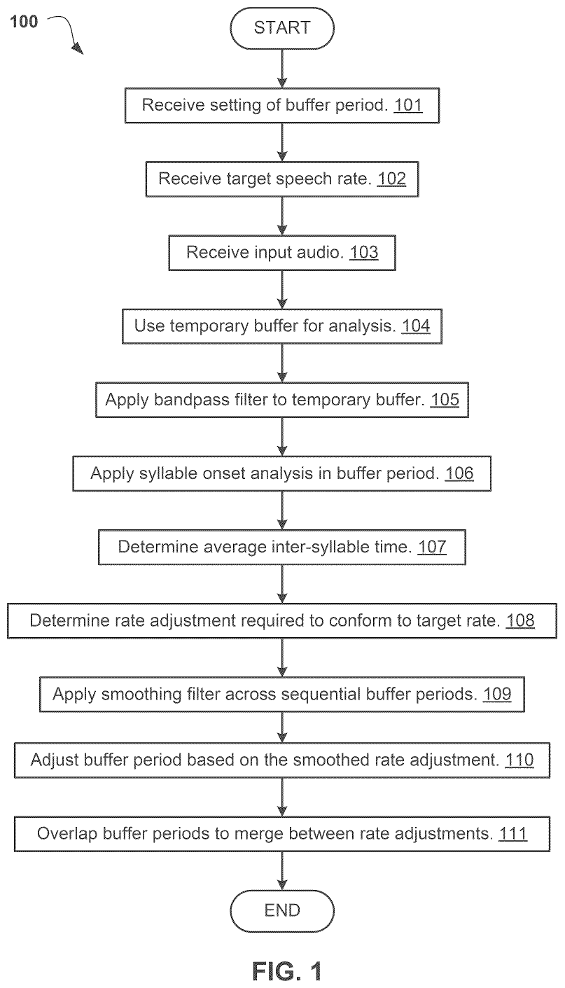

Referring to FIG. 1, an operational flowchart illustrating a speech rate adjusting process is depicted, according to at least one embodiment. The audio input may be a real-time steaming of audio or may be an offline playback of a recorded audio. The audio input may include one or more voices.

At 101 the method may receive a setting of a buffer period length. In real-time streaming of the audio input, the buffer period will be the latency of the streaming. The buffer period length may be set based on processing availability and required latency. The buffer period may be set as a time period that includes at least three words. The buffer period may be, as an example only, a time period of between 2 and 5 seconds.

In an offline use of the described method, the buffer period may be of varied length based on a word or sentence. The method may adjust the buffer period based on the speech input to avoid a buffer cut off mid-utterance, wherein an utterance is a syllable, word, or sentence. The buffer may be prolonged to prevent it cutting in the middle of a word or sentence. A step may be provided which detects whether the “normal” buffer end is within a syllable, word, or sentence, and may prolong the buffer to locate the end. The end of the word or sentence may be detected by detecting silence for a certain amount of time (for example, 0.1 sec). There may also be a maximum length of the variable buffer period if there is continuous talk with no silent gaps between sentences.

At 102, the method may receive an input of a target speech rate for a user. This may be a setting provided to a user for input via a user interface of an audio playback application. There may be a default target speech rate that may be applied if no input is received from a user.

At 103, the method receives the audio input. At 104, the method may use a temporary buffer equal to the length of the buffer period for processing the audio input, including copying the input audio in the current buffer period into the temporary buffer. At 105, the method may apply a bandpass filter to the copied input audio based on a selected voice range, for example, for male, female, adult, and child voice frequencies.

At 106, the method applies syllable onset analysis to the speech input in a buffer period. This may be applied in the temporary buffer. Known techniques for syllable onset analysis may be used that involves the identification of onsets, which are peaks or transients, usually followed by a stationary part. Onset analysis treats long vowels such as “aaaa” the same as a short consonant such as “m.”

For example, although the word “ahaaaa” might have the same duration as the word “millennium,” the latter has four syllables (mi-lle-ni-um) while the first one has two (a-haa). Therefore, the latter cannot be speed up as much as the first because it has a higher syllable frequency and would be much more difficult to understand/hear than the first one. Thus, the first one gives a much higher degree of freedom for bringing speed up.

At 107, the method determines an average inter-syllable time for the buffer period. In one embodiment, this may determine a median inter-syllable time to remove sensitivity to outliers. However, other methods such as a Gaussian method or a mean method may be used.

At 108, the method determines a rate adjustment required for the average inter-syllable time of the buffer period to conform to a target speech rate. A rate adjustment may be a ratio of the average inter-syllable time over the buffer period to the target rate.

At 109, the method applies a smoothing filter to smooth the rate adjustments across multiple sequential buffer periods. This prevents abrupt changes in a speech rate. Applying a smoothing filter may apply a smoothing filter that requires multiple consecutive rate adjustment values changing in a same direction before changing direction of a rate adjustment. Applying a smoothing filter may apply a smoothing filter in a moving average window.

At 110, the method adjusts the buffer period length based on the rate adjustment or the smoothed rate adjustment when the smoothing filter is applied. The rate adjustment indicates an amount of stretching of the buffer period required to conform to the target speech rate. Adjusting the buffer period stretches the buffer period by a determined positive or negative ratio based on the rate adjustment. Time stretching may be above 100% making it longer, thus slower, or below 100% making it shorter, and therefore faster.

At 111, the method overlaps buffer periods to modify a signal in an overlapping portion for a smooth transition between the rate adjustments of adjacent buffer periods. In at least one example embodiment, overlapping buffer periods result in the modification of the signal between the rate adjustments by applying a decreasing vector multiplication to a signal of an overlapping end portion of a preceding buffer and an increasing multiplication vector to a signal of an overlapping start portion of a following buffer.

In embodiments, the described method may take the median of sorted inter-syllable times or another average measure and adjusts the ratio of the time stretch as a percentage increase or decrease in each buffer using a trajectory and overlapping windows. This aims to provide a constant speech rate according to the user's preference.

The output is a smooth speech audio in which the rate of the speech is kept at a certain constant rate. Although different speakers may speak, the speech delivery rate is kept constant. Similarly, a single speaker may vary their speech delivery rate in an input, and this may be kept constant by the described method.

As an example, a user may like a fast delivery, such as 20% faster than an average person. This increased rate may be selected and applied. Only the sections of the input speech that need to be sped up have a rate increase. If the speaker speaks at the desired rate for a period, then nothing is done to adjust it. Such a period may be just a few seconds. Thus, the system adapts continuously to the speech input and adjusts only when necessary. The user will not notice much difference in quality and speed as the method makes the speech flow smoothly.

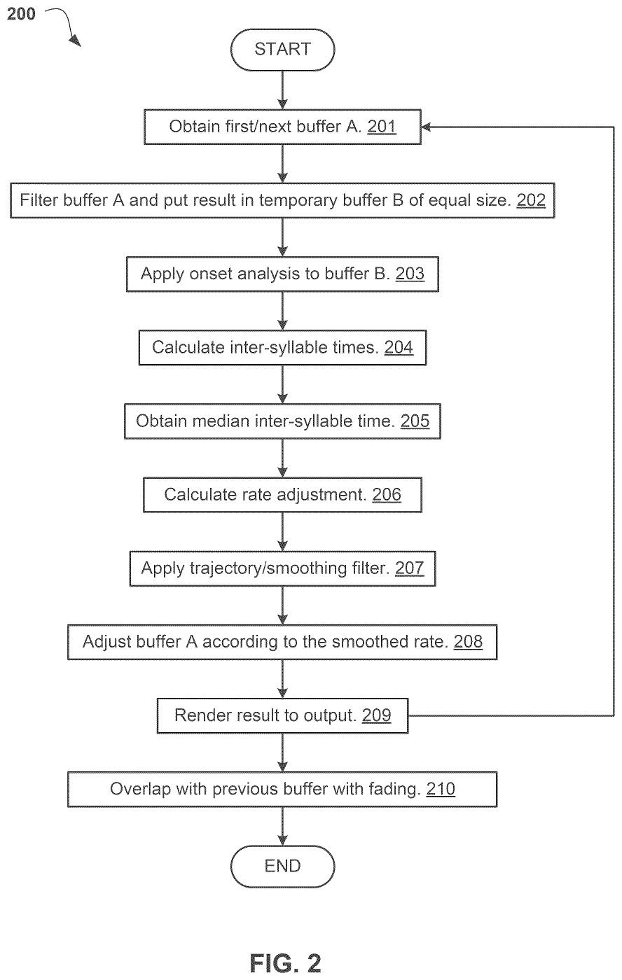

Referring to FIG. 2, a flow diagram 200 illustrates another example embodiment of the described method of a computer-implemented method for adjusting speech rate for an audio input. The flow diagram 200 is used to discuss additional optional implementation details of the described method.

At 201, the method obtains first or next buffer A. The buffer period may have a length of a few words up to a sentence at a normal speech rate. Therefore, the buffer period may be between approximately 2-5 seconds. The buffer period should be small enough to capture changes and large enough to give data to the statistical function that finds the mean syllable rate through the onset analysis. The buffer period may be adjusted if required due to processing requirements.

At 202, the method may filter the audio in the buffer A and put the results in temporary buffer B of equal size to buffer A. The method may also normalize the audio in buffer A as part of the filtering. Buffer B is a temporary buffer which is “thrown away” after each buffer analysis.

In embodiments, the method uses a bandpass filter to remove possible low frequency rumble, 50/60 Hz power supply humming and high frequency noise. The lower and higher frequencies are chosen with a margin to include all formant regions for males and females, children, and adults. For example, the bandpass filter may filter between 300 Hz and 2700 Hz.

At 203, the method then applies onset analysis to identify onsets in the filtered buffer B. An onset is often followed by a stationary section, but the stationary section is not of interest here. The method is interested in obtaining the start of each syllable, which is the onset of it. For example, a long “aaaaaa” which lasts for a second only has one onset, because it starts with a peak and is followed by a stationary section which then fades out.

At 204, once the onsets have been identified, the times between the offsets referred to as inter-syllable times are calculated through the delta of each pair onset.

At 204, the method may obtain the median inter-syllable time by sorting and finding the middle value of the inter-syllable values. The median value is used because it is not as sensitive for outliers as other averaging methods. If the mean average is used, then an outlier would have a relatively high impact on the result and could impact results. With the median value, there is no impact because the inter-syllable times are sorted and most of them will be centered around the same value. However, if the median operation is too expensive on a given hardware or if there is another reason, then the mean average may be used. This median value represents the average syllable rate of the buffer and the degree of adjustment that needs to be done can be calculated using the target syllable rate and the average syllable rate.

At 206, the method calculates a rate adjustment needed to adjust the median inter-syllable time for the buffer period to the target speech rate. The adjustment required may be calculated as a ratio adjustment to stretch the audio in the buffer period.

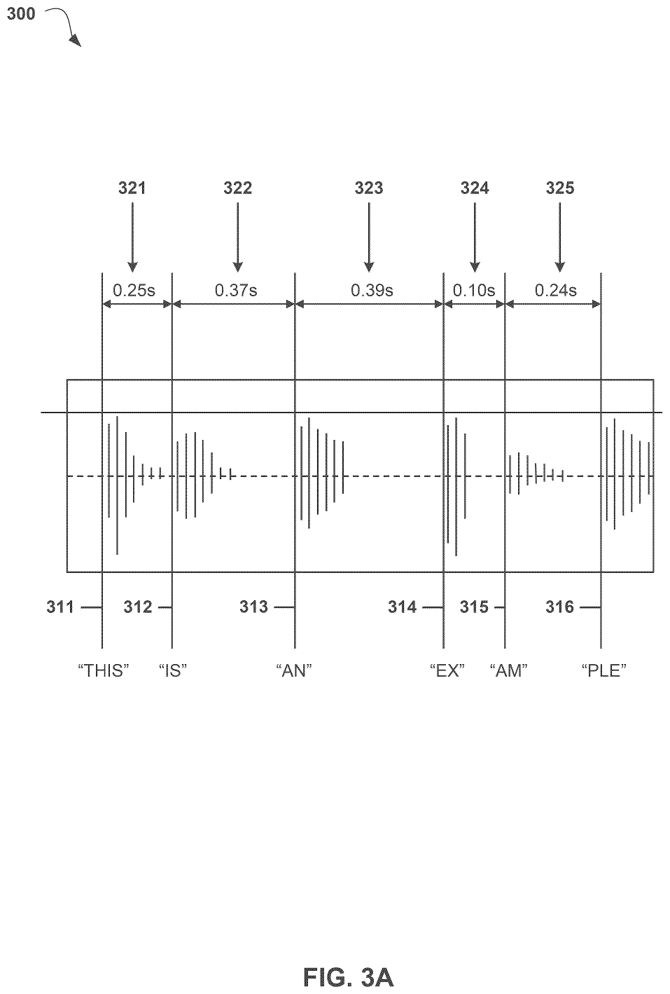

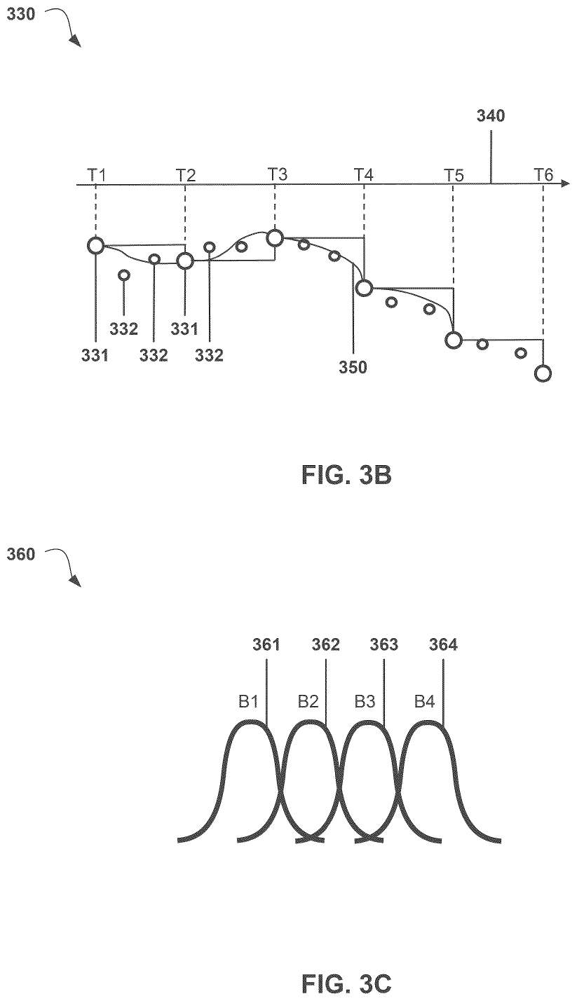

At 207, the method applies a trajectory smoothing filter to smooth the rate changes over consecutive buffers. This is explained further with reference to FIG. 3B below.

In embodiments, the smoothing filtering obtains a trajectory of ratios for moving from one ratio to another and smooths these over a moving average window. The smoothing filter may be a lowpass filter. The smoothing filter does not react on each buffer rate adjustment point but applies a moving average window with a certain lookback onto the rate adjustment points. The smoothing filter removes or minimizes an impact of a single outlier or two or three consecutive outliers.

At 208, the method adjusts a rate of speech in buffer A according to a smoothed rate of adjustment for the buffer. At 209, the buffer A is stretched accordingly and rendered to the output. The rate adjustment may be carried out by time domain harmonic scaling. The method may then loop to process a next buffer 201.

At 210, the method applies an overlap when rendering the output such that consecutive buffers are transitioned at an overlapping portion to avoid artifacts in the audio output at the buffer boundaries. The overlap application is described further with reference to FIG. 3C.

FIG. 3A shows a schematic diagram 300 that illustrates an example embodiment of the aspect of the method of syllable onset analysis. At 310, a buffer period 0 is shown and within the buffer period 310 syllables onsets 311-316 are identified. The inter-syllable times 321-325 are determined and a median rate of 0.25 seconds is calculated. A user target rate has been set at 0.22 seconds and therefore a rate adjustment of 85% is required to stretch the audio.

FIG. 3B shows a schematic diagram 330 of an example embodiment illustrating the aspect of the method of smoothing a rate adjustment.

In embodiments, the average syllable time in each buffer is measured and are plotted at smaller circle plots 331 and larger circle plots 332 as a function of time along timeline 340 to produce a graph which forms a trajectory 350.

In embodiments, the trajectory 350 is created from the larger circle plots 331 that are “correct”. The smaller circle plots 332 are offset a little bit from the trajectory 350, thus they are outliers from a smooth rate adjustment. The diagram 330 represents speech at times T1, T2, T3, T4, T5 and T6 along a timeline 340. At T1 a person starts to speak, he/she then increases the pace a little bit at T2, so the average syllable rate moves down a little bit. At T3, the person starts to speak slowly again and then the average syllable time goes up. Then from T4 and onwards, the speech speeds up and again and the average syllable time moves down step by step until T6.

A smoothing filter is applied that does not apply the average syllable rate as it is. The first smaller circle plot 332 would cause the output to slow down the speech more than what is needed. Instead, the average syllable values represented by circle plots 331, 332 for the buffers go into a smoothing filter which smooths outputs over consecutive changes. The smoothing filter may regulate outputs based on the direction of the output trajectory.

For example, the smoothing may require multiple consecutive values being received in the same direction before the trajectory 350 changes direction. For example, if one received value V1 jumps up more than what would be expected, the output will move up as well but not as much as to V1 but for example to 65% of V1. If the next value jumps up too, then the filter may result in an output at V1 or above, but it took one or two samples in the same direction to move it there. In another example, if every second sample is up and down then the smoothing filter will end up horizontal.

FIG. 3C shows a schematic diagram 360 of an example embodiment of an aspect of the method of overlapping buffers 361-364.

Since the method operates on buffers to retrieve the average syllable time and to apply the rate adjustment, there is a transition at the seam between two buffers, which can create a click or pop. By overlapping two consecutive buffers slightly (can be very short, e.g., 1 millisecond), a potential click at the seam will be removed.

The section that overlaps both buffers is calculated as to how it should be output. One method is to fade out of buffer 1 and fade in to buffer 2. Another method is to adapt the overlapping section to a smooth transition between the two buffers.

In the fading example embodiment, the first samples of a next buffer will use the last samples from the previous buffer. The first samples in a next buffer may be faded in and the last samples from the previous buffer may be faded out. This may be implemented by the first samples in a next buffer being multiplied with a vector that goes from 0 to 1.0 and by the last samples of the previous buffer being multiplied with a vector that goes from 1.0 to 0 and the result will replace the first samples of the next buffer.

FIG. 3C shows four buffers 361-364 which overlap. At the end of the buffer 361, the amplitude decreases and at the same time the amplitude of the second buffer 362 starts to increase. The overlap section may be very small and negligible to a human. At 44100 kHz sampling rate, equaling 44100 samples per second, the overlap may be less than 100 samples, for example, 32 samples that overlap and thus less than a millisecond.

Since each buffer does a time rate adjustment at regular intervals, according to the trajectory shown in FIG. 3B, there may be audible clicking sounds at points in the playback marking seams where there is a transition from one buffer to the next. The smoothing filter reduces the effect; however, the rate will still change between two consecutive buffers. Therefore, the overlapping buffers are used to remove the transition clicks completely as the buffers overlap.

Embodiments of the invention use syllable onset to find syllables to compute an average syllable rate for a buffer and adjust the buffer into the desired syllable rate by time stretching the buffer. There are many reasons why a listener would prefer the speech to be locked into a specific rate, down on syllable level, rather than applying a single speed that is not adaptive.

The combination of the average inter-syllable time-based rate adjustment in combination with a smoothing filter creates a smooth result. Overlapping buffers further improve the result. Without the smoothing filter, then there may be occasional outliers that will create an abrupt rate change between buffers. Without the overlapping buffers there may be clicks in the audio formed by the rate change.

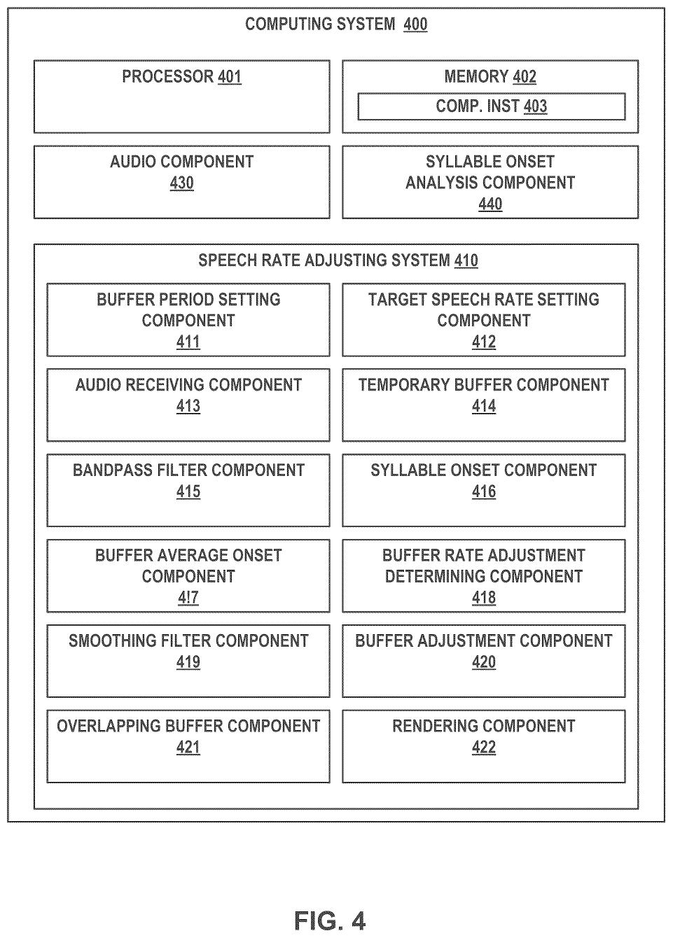

Referring to FIG. 4, a block diagram shows a computing system 400 for implementing a speech rate adjusting system 410.

The computing system 400 may include at least one processor 401, a hardware module, or a circuit for executing the functions of the described components which may be software units executing on the at least one processor. Multiple processors running parallel processing threads may be provided enabling parallel processing of some or all of the functions of the components. Memory 402 may be configured to provide computer instructions 403 to the at least one processor 401 to carry out the functionality of the components.

The speech rate adjusting system 410 may be provided in association with an audio component 430 such as an audio streaming or playback application.

The speech rate adjusting system 410 may include a buffer period setting component 411 for adjusting the length of the buffer period. The buffer period setting component 411 may include a variable buffer period setting for offline use including determining word or sentence ends before cutting off a buffer. The speech rate adjusting system 410 may include a target speech rate setting component 412 for setting a user's target speech rate. The target speech rate setting component 412 may have an input provided in a user interface for setting by a user.

The speech rate adjusting system 410 may include an audio receiving component 413 for receiving an audio input from the audio component 430.

The speech rate adjusting system 410 may include a temporary buffer component 414 for using a temporary buffer of a same length as buffer period. The speech rate adjusting system 410 may include a bandpass filter component 415 for applying a bandpass filter to the temporary buffer based on a selected voice range.

The speech rate adjusting system 410 may include a syllable onset analysis component 416 for applying syllable onset analysis to a received speech input in a buffer period. The syllable onset component 416 may use a separate syllable onset analysis component 440 such as a remote analysis component or may provide this functionality locally.

The speech rate adjusting system 410 may include a buffer average onset component 417 for determining an average inter-syllable time for the buffer period.

The speech rate adjusting system 410 may include a buffer rate adjustment determining component 418 for determining a rate adjustment required for the average inter-syllable time of the buffer period to conform to a target speech rate.

The speech rate adjusting system 410 may include a smoothing filter component 419 applying a smoothing filter to smooth the rate adjustments across multiple sequential buffer periods.

The speech rate adjusting system 410 may include a buffer adjustment component 420 for adjusting the buffer period based on the rate adjustment or smoothed rate adjustment when the smoothing filter component 419 is used. Adjusting the buffer period stretches the buffer period by a determined positive or negative ratio based on the smoothed rate adjustment.

The speech rate adjusting system 410 may include an overlapping buffer component 421 for overlapping buffer periods to modify a signal in an overlapping portion for a smooth transition between the rate adjustments.

The speech rate adjusting system 410 may include an audio rendering component 422 for outputting the adjusted audio.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

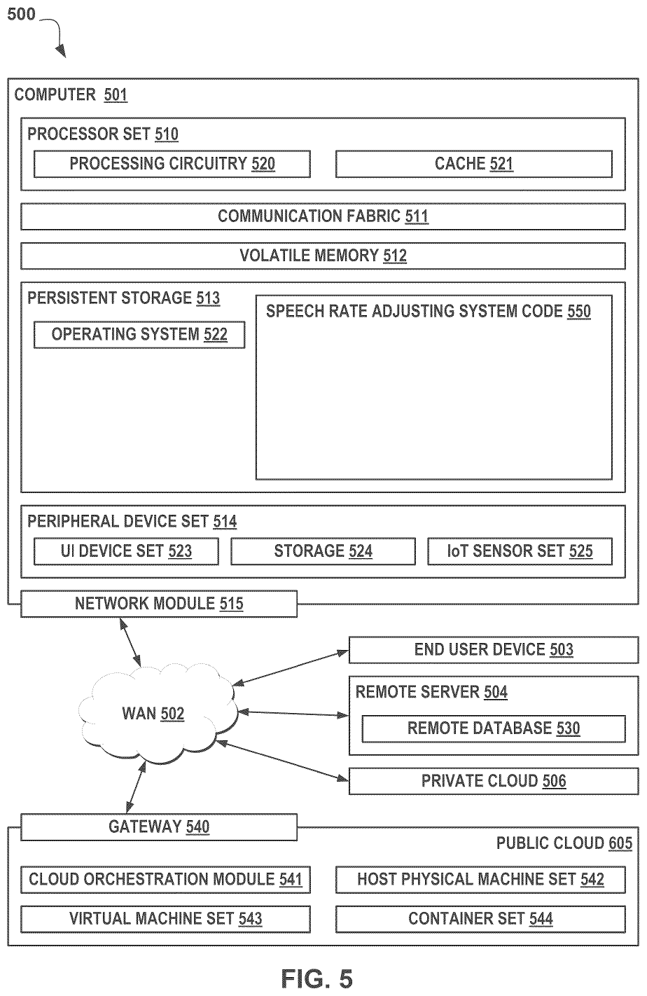

Referring to FIG. 5, computing environment 500 illustrates an example of an environment for the execution of at least some of the computer code involved in performing the inventive methods, such as speech rate adjusting system code 550. In addition to speech rate adjusting system code 550, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and speech rate adjusting system code 550, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in speech rate adjusting system code 550 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid-state storage devices. Operating system 522 may take several forms, such as various known proprietary operating systems or open-source Portable Operating System Interface-type operating systems that employ a kernel. The code included in speech rate adjusting system code 550 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

What is claimed is:

1. A computer-implemented method for adjusting speech rate for an audio input, the method comprising:
applying syllable onset analysis to speech input in a buffer period;
determining an average inter-syllable time for the buffer period;
determining a rate adjustment required for the average inter-syllable time of the buffer period to conform to a target speech rate;
applying a smoothing filter to smooth the rate adjustment across multiple sequential buffer periods; and
adjusting the buffer period based on the smoothed rate adjustment.

2. The method of claim 1, including:
overlapping buffer periods and modifying a signal in an overlapping portion for a smooth transition between the smoothed rate adjustments of adjacent buffer periods.

3. The method of claim 1, wherein adjusting the buffer period stretches the buffer period by a determined positive or negative ratio based on the smoothed rate adjustment.

4. The method of claim 1, wherein the method is carried out for a real-time audio input with a latency equal to the buffer period.

5. The method of claim 1, wherein the method is carried out for an offline audio input and includes:
adjusting the buffer period based on the speech input to avoid a buffer cut off mid-utterance.

6. The method of claim 1, wherein the method further comprises:
using a temporary buffer of a same length as buffer period for syllable onset analysis; and
applying a bandpass filter to the temporary buffer based on a selected voice range.

7. The method of claim 1, wherein determining an average inter-syllable time for the buffer period determines a median inter-syllable time to remove sensitivity to outliers.

8. The method of claim 1, wherein applying the smoothing filter to smooth the rate adjustments across the multiple sequential buffer periods applies the smoothing filter that requires multiple consecutive rate adjustment values changing in a same direction before changing direction of a rate adjustment.

9. The method of claim 1, wherein applying the smoothing filter to smooth the rate adjustments across the multiple sequential buffer periods applies the smoothing filter in a moving average window.

10. The method of claim 1, the method further comprising:
receiving a target speech rate for a user for the audio input.

11. The method of claim 1, wherein the audio input includes one or more voices.

12. A system comprising:
a processor, a memory device coupled to the processor, and a computer readable storage device coupled to the processor, wherein the storage device contains program code executable by the processor via the memory device to implement a method for adjusting speech rate for an audio input, the method comprising:
applying syllable onset analysis to speech input in a buffer period;
determining an average inter-syllable time for the buffer period;
determining a rate adjustment required for the average inter-syllable time of the buffer period to conform to a target speech rate;
applying a smoothing filter to smooth the rate adjustments across multiple sequential buffer periods; and
adjusting the buffer period based on the smoothed rate adjustment.

13. The system of claim 12, wherein the method includes:
overlapping buffer periods and modifying a signal in an overlapping portion for a smooth transition between the smoothed rate adjustments of adjacent buffer periods.

14. The system of claim 12, wherein adjusting the buffer period stretches the buffer period by a determined positive or negative ratio based on the smoothed rate adjustment.

15. The system of claim 12, wherein the audio input is a real-time steaming of audio with a latency of the buffer period.

16. The system of claim 12, wherein the method is carried out for an offline audio input and includes:
adjusting a length of a buffer period based on the speech input to avoid a buffer cut off mid-utterance.

17. The system of claim 12, wherein the method includes:
using a temporary buffer of a same length as buffer period for syllable onset analysis; and
applying a bandpass filter to the temporary buffer based on a selected voice range.

18. The system of claim 12, wherein applying the smoothing filter to smooth the rate adjustments across the multiple sequential buffer periods applies the smoothing filter that requires multiple consecutive rate adjustment values changing in a same direction before changing direction of a rate adjustment.

19. The system of claim 12, wherein applying the smoothing filter to smooth the rate adjustments across the multiple sequential buffer periods applies the smoothing filter in a moving average window.

20. A computer-implemented method for adjusting speech rate for an audio input, the method comprising:
applying syllable onset analysis to speech input in a buffer period;
determining an average inter-syllable time for the buffer period;
determining a rate adjustment required for the average inter-syllable time of the buffer period to conform to a target speech rate;
adjusting the buffer period based on the rate adjustment; and
overlapping consecutive buffer periods in the audio input and modifying an output signal in an overlapping portion for a smooth transition between adjacent buffer periods.

21. The method of claim 20, including:
applying a smoothing filter to smooth the rate adjustments across multiple sequential buffer periods.

22. The method of claim 20, wherein adjusting the buffer period stretches the buffer period by an amount based on the rate adjustment.

23. A system comprising:
a processor, a memory device coupled to the processor, and a computer readable storage device coupled to the processor, wherein the storage device contains program code executable by the processor via the memory device to implement a method for adjusting speech rate for an audio input, the method comprising:
applying syllable onset analysis to speech input in a buffer period;
determining an average inter-syllable time for the buffer period;
determining a rate adjustment required for the average inter-syllable time of the buffer period to conform to a target speech rate; and
adjusting the buffer period based on the rate adjustment; and
overlapping consecutive buffer periods in the audio input and modifying an output signal in an overlapping portion for a smooth transition between adjacent buffer periods.

24. A computer program product comprising:
one or more computer-readable tangible storage medium and program instructions stored on at least one of the one or more tangible storage medium, the program instructions executable by a processor to cause the processor to perform a method for adjusting speech rate for an audio input, the method comprising:
applying syllable onset analysis to speech input in a buffer period;
determining an average inter-syllable time for the buffer period;
determining a rate adjustment required for the average inter-syllable time of the buffer period to conform to a target speech rate;
applying a smoothing filter to smooth the rate adjustments across multiple sequential buffer periods; and
adjusting the buffer period based on the smoothed rate adjustment.

25. The computer program product of claim 24, further comprising:
overlapping consecutive buffer periods in the audio input and modifying an output signal in an overlapping portion for a smooth transition between adjacent buffer periods.
